(19) United States
(12) Patent Application Publication
(10) Pub. No.: US 2020/0082472 A1
(43) Pub. Date: Mar. 12, 2020

(54) SYSTEMS AND METHODS FOR PROVIDING ELECTRONIC SERVICES AT A POINT OF SALE

(71) Applicant: Apple Inc., Cupertino, CA (US)

(72) Inventors: Farman A. Syed, San Jose, CA (US); Stephen W. Quirk, Millburn, NJ (US); Kirsten J. Green, San Francisco, CA (US); Peter J. Hare, San Francisco, CA (US); Lucas R. Wolf, San Jose, CA (US); Peien V. Liu, San Francisco, CA (US)

(21) Appl. No.: 16/128,313

(22) Filed: Sep. 11, 2018

(51) Int. Cl. G06Q 40/08; G06Q 20/20; G06Q 20/40

(52) U.S. Cl. CPC G06Q 40/08; G06Q 20/401; G06Q 20/20

(57) ABSTRACT

A method may include receiving a purchase payload including an electronic service order indication that specifies an electronic service product purchased proximate to a purchase of an electronic device with which the electronic service product is to be associated. The purchase payload may include a unique device identifier that identifies the electronic device and an electronic service identifier that identifies the electronic service product. The method may also include receiving a qualifying event indication associated with the electronic device indicating that a qualifying event associated with the unique device identifier has occurred. The method may also include triggering, in response to the qualifying event, activation of the electronic service product identified by the electronic service identifier for the electronic device identified by the unique device identifier.

### BACKGROUND

The present disclosure relates generally to techniques for providing electronic services at a point of sale of an electronic device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Electronic service products are used to provide various software features and functions in numerous electronic devices, from mobile phones or cellular devices to computers, televisions, automobile dashboards, and many more. A customer buying an electronic device may elect at checkout to purchase one or more electronic service products. The customer may be charged in response to the purchase of the electronic device completing. However, in some cases, it may not be desirable to activate and/or complete the charges associated with an electronic service product at the time of purchase of an electronic device. For example, some period of time may pass between a customer purchasing an electronic device and a user using the electronic service product for the first time, such as when the electronic device and the electronic service product are purchased as part as a gift. In this way, resources may be wasted both on the side of the customer (e.g., financial resources, time) and on the side of an electronic service product provider (e.g., computing resources associated with maintaining a digital profile of the electronic service product, even while not in use).

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Methods and systems for postponing activation and/or purchase of electronic service products to a time different from an order generation of the electronic service products are provided herein. These techniques may provide a number of improvements in technological arts, including but not limited to improved user experiences with the purchased electronic device, and, in some cases, conservation of customer and computing resources. To improve a user experience with purchasing electronic service products, a back end computing device may maintain records associating orders, unique device identifiers, and electronic service product identifiers to each other after a customer-initiated purchase. At the point of sale, a customer may commit to purchasing an electronic service product at a future time, causing an order to be generated where the unique device identifier of the purchased electronic device is associated with any electronic service products that the customer committed to purchasing. A server coupled to the back end computing device may maintain a database of the unique device identifiers and the electronic service products. The back end computing device may operate to delay activation of the electronic service product until a qualifying event occurs. A qualifying event may include a user powering on the purchased electronic device, the user selecting or opening an application for use, the user accessing digital content for use via the electronic service product, a pre-determined amount of time passing, a shipment of the purchased electronic device being completed, or the like. In response to the qualifying event occurring, the back end computing device may query the server to determine relevant electronic service products based on the unique device identifier of the purchased electronic device and the qualifying event.

These systems and methods may also provide infrastructure to perform linking tasks such as linking a digital user profile to the serial number of the purchased electronic device and the purchased electronic service product and/or linking the digital user profile to a payment method used to purchase the purchased electronic device and the purchased electronic service product. In addition, the purchased electronic device may communicate with the back end computing device to provide a subscription management page that displays to a user a summary of activated subscriptions, account information for each subscriptions, and/or renewal periods associated with the subscriptions of the digital user profile. Furthermore, since electronic service products are associated to the user via the digital user profile, the electronic service products may be used across a variety of device platforms that also use the digital user profile. In this way, various graphical user interfaces may be generated and presented to the user based on their digital user profile and/or based on information associated with the digital user profile or purchased electronic device (e.g., data stored in the database).

### BRIEF DESCRIPTION OF THE DRAWINGS

Various aspects of this disclosure may be better understood upon reading the following detailed description and upon reference to the drawings in which:

FIG. 1 is a schematic block diagram of an electronic device, according to embodiments of the present disclosure;

FIG. 2 is a perspective view of a notebook computer representing an embodiment of the electronic device of FIG. 1;

FIG. 3 is a front view of a hand-held device representing another embodiment of the electronic device of FIG. 1;

FIG. 4 is a front view of another hand-held device representing another embodiment of the electronic device of FIG. 1;

FIG. 5 is a front view of a desktop computer representing another embodiment of the electronic device of FIG. 1;

FIG. 6 is a front view and side view of a wearable electronic device representing another embodiment of the electronic device of FIG. 1;

FIG. 7 is a block diagram of a system to complete a customer-initiated purchase of a new device and associated electronic services, in accordance with an embodiment;

FIG. 8 is a flowchart of a process for activating an electronic service associated with the customer-initiated purchase of FIG. 7, in accordance with an embodiment;

FIG. 9A-F are illustrations depicting the customer-initiated purchase of FIG. 7 from the perspective of a retail computing device in a physical retail store, in accordance with an embodiment;

FIGS. 10A-C are illustrations depicting the customer-initiated purchase of FIG. 7 from the perspective of a retail computing device on a mobile platform, in accordance with an embodiment;

FIG. 11 is a flowchart of a process for processing payment methods and activating electronic service products in response to the customer-initiated purchase of FIG. 7, in accordance with an embodiment;

FIG. 12 is a flowchart of a process for processing payment methods and activating electronic service products in response to the customer-initiated purchase of FIG. 7, in accordance with an embodiment;

FIG. 13 is a flowchart of a process for activating and renewing electronic services associated with the customer-initiated purchase of FIG. 7, in accordance with an embodiment;

FIGS. 14A-C are illustrations depicting a linking flow associated with the method for activating and renewing electronic services of FIG. 12, in accordance with an embodiment;

FIGS. 15A-D are illustrations depicting a linking flow associated with the method for activating and renewing electronic services of FIG. 12, in accordance with an embodiment;

FIGS. 16A-E are illustrations depicting an example of a qualifying event, in accordance with an embodiment;

FIG. 17 is an illustration depicting a second example of a qualifying event, in accordance with an embodiment; and

FIGS. 18A-B are illustrations depicting multiple activated subscriptions, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of the present disclosure relate to systems and methods for processing customer-initiated purchases of new electronic devices separate from processing customer-initiated purchases of corresponding subscriptions to be associated with the new electronic device. Purchased electronic devices may be associated with a variety of electronic services, such as music listening applications or news-providing applications, where to access content via an application, a user pays a fee on a predetermined time interval to retain access to the application. Further, additional electronic services may include electronic device insurance services or other services tied to a particular electronic device. These electronic services may be purchased as electronic service products and ordered at the time of hardware purchase (e.g., at the time of purchasing of the one or more electronic devices), and thus may be associated with a serial number of the purchased hardware. In this way, at an order time of the electronic service product and electronic device, a user identification may not be collected and instead the serial number of the purchased electronic device may be linked with one or more electronic services to facilitate purchase and/or activation of the electronic service product at a later time. Through delaying purchasing and/or activation of the electronic services until a later time, customers receive an improved experience with the electronic services subscribed to, since preemptive charging may be delayed until the user actually uses the electronic services for the first time. In addition, a back end computing device may save the payment method used to activate the electronic service products to automatically renew the electronic services on behalf of the customer at predetermined timing intervals (e.g., service periods).

The systems and methods of this disclosure may facilitate the collection and management of customer personal data, payment methods, and device serial numbers, permitting the collected data to be associated with a digital identification of the customer. This collection may improve the interaction of the customer with purchased electronic devices through streamlining future payments and permitting various personal data to be auto-filled when suitable.

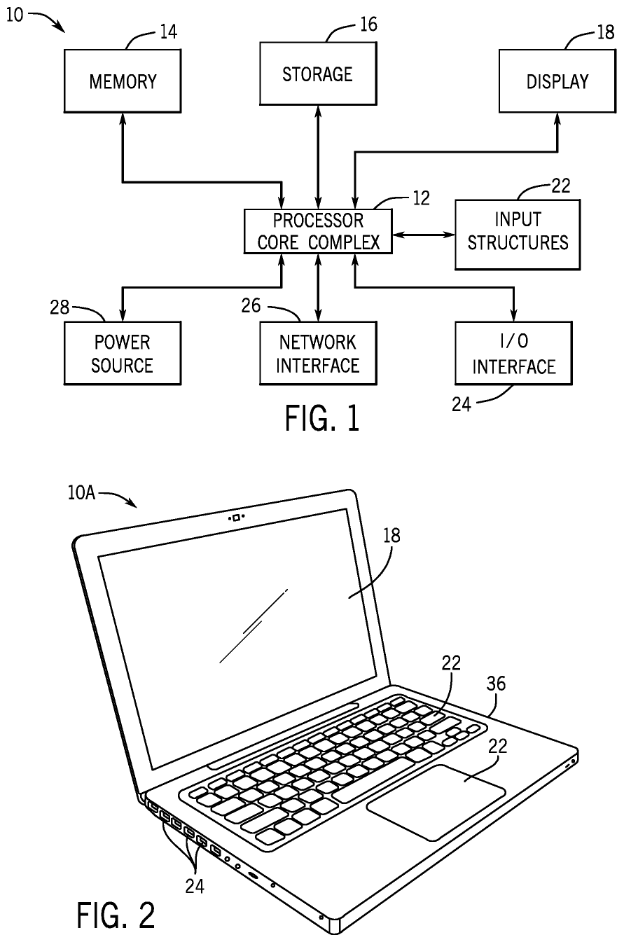

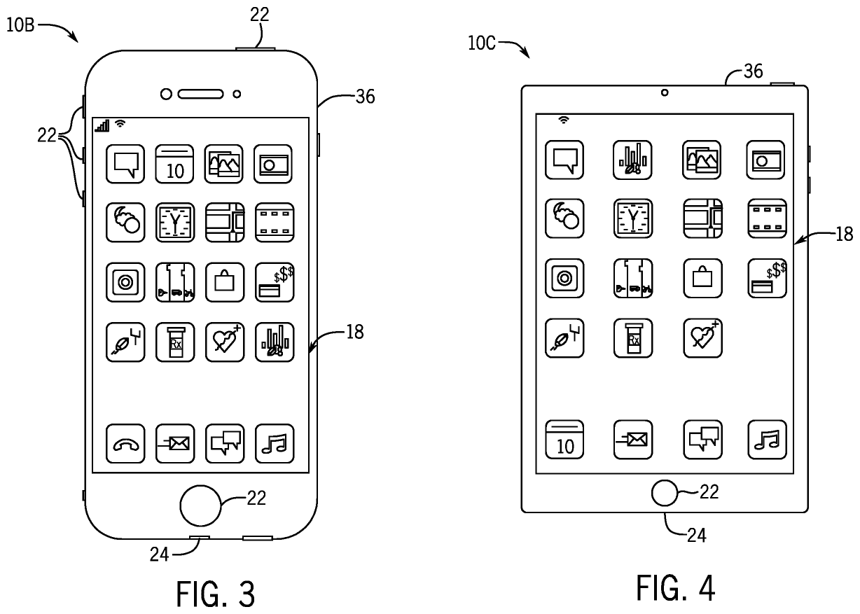

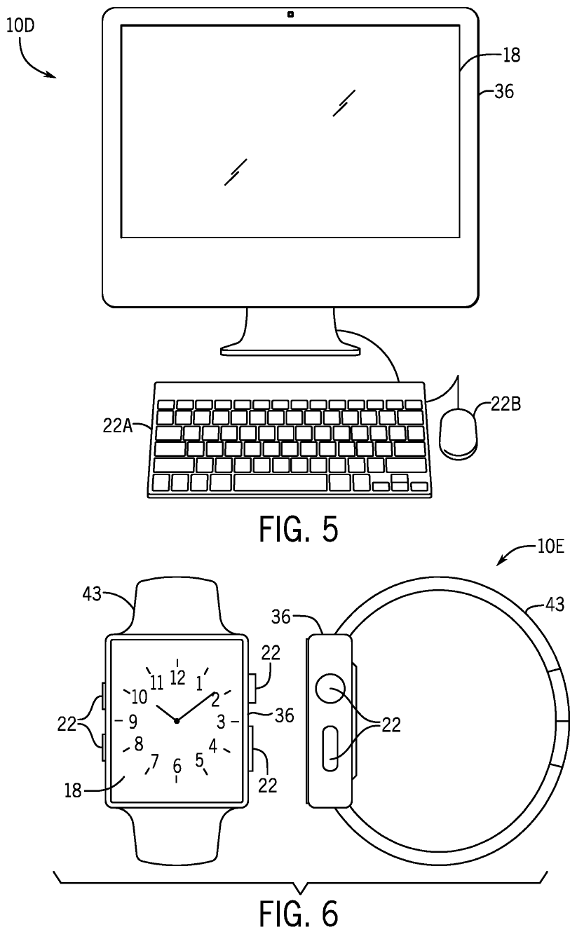

With this in mind, a block diagram of an electronic device 10 is shown in FIG. 1. As will be described in more detail below, the electronic device 10 may represent any suitable electronic device, such as a computer, a mobile phone, a portable media device, a tablet, a television, a virtual-reality headset, a vehicle dashboard, or the like. The electronic device 10 may represent, for example, a computer 10A as depicted in FIG. 2, a handheld device 10B as depicted in FIG. 3, a handheld device 10C as depicted in FIG. 4, a desktop computer 10D as depicted in FIG. 5, a wearable electronic device 10E as depicted in FIG. 6, or a similar device.

The electronic device 10 shown in FIG. 1 may include, for example, a processor core complex 12, a local memory 14, a main memory storage device 16, an electronic display 18, input structures 22, an input/output (I/O) interface 24, a network interface 26, and a power source 28. The various functional blocks shown in FIG. 1 may include hardware elements (including circuitry), software elements (including machine-executable instructions stored on a tangible, non-transitory medium, such as the local memory 14 or the main memory storage device 16) or a combination of both hardware and software elements. It should be noted that FIG. 1 is merely one example of a particular implementation and is intended to illustrate the types of components that may be present in electronic device 10. Indeed, the various depicted components may be combined into fewer components or separated into additional components. For example, the local memory 14 and the main memory storage device 16 may be included in a single component.

The processor core complex 12 may carry out a variety of operations of the electronic device 10. The processor core complex 12 may include any suitable data processing circuitry to perform these operations, such as one or more microprocessors, one or more application specific processors (ASICs), or one or more programmable logic devices (PLDs). In some cases, the processor core complex 12 may execute programs or instructions (e.g., an operating system or application program) stored on a suitable article of manufacture, such as the local memory 14 and/or the main memory storage device 16. In addition to instructions for the processor core complex 12, the local memory 14 and/or the main memory storage device 16 may also store data to be processed by the processor core complex 12. By way of example, the local memory 14 may include random access memory (RAM) and the main memory storage device 16 may include read only memory (ROM), rewritable non-volatile memory such as flash memory, hard drives, optical discs, or the like.

The electronic display 18 may display image frames, such as a graphical user interface (GUI) for an operating system or an application interface, still images, or video content. The processor core complex 12 may supply at least some of the image frames. For example, the processor core complex 12 may supply image frames that display a product selection menu to facilitate customer-initiated purchasing of products and electronic services. The electronic display 18 may be a self-emissive display, such as an organic light emitting diodes (OLED) display, a light emitting diode (LED) display, a digital micromirror device (DMD) display, a liquid crystal display (LCD) illuminated by a backlight, or the like. In some embodiments, the electronic display 18 may include a touch screen, which may permit users to interact with a user interface of the electronic device 10.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. The network interface 26 may include, for example, interfaces for a personal area network (PAN), such as a Bluetooth network, for a local area network (LAN) or wireless local area network (WLAN), such as an 802.11x Wi-Fi network, and/or for a wide area network (WAN), such as a cellular network. The network interface 26 may also include interfaces for, for example, broadband fixed wireless access networks (WiMAX), mobile broadband Wireless networks (mobile WiMAX), asynchronous digital subscriber lines (e.g., ADSL, VDSL), digital video broadcasting-terrestrial (DVB-T) and its extension DVB Handheld (DVB-H), ultra wideband (UWB), alternating current (AC) power lines, and so forth. The power source 28 may include any suitable source of power, such as a rechargeable lithium polymer (Li-poly) battery and/or an alternating current (AC) power converter.

In certain embodiments, the electronic device 10 may take the form of a computer, a portable electronic device, a wearable electronic device, or other type of electronic device. Such computers may include computers that are generally portable, such as laptop, notebook, and tablet computers, as well as computers that are generally used in one place, such as conventional desktop computers, workstations and/or servers. In certain embodiments, the electronic device 10 in the form of a computer may be a model of a MacBook®, MacBook® Pro, MacBook Air®, iMac®, Mac® mini, or Mac Pro® available from Apple Inc. By way of example, the electronic device 10, taking the form of a computer 10A, is illustrated in FIG. 2 according to embodiments of the present disclosure. The depicted computer 10A may include a housing or enclosure 36, an electronic display 18, input structures 22, and ports of an I/O interface 24. In one embodiment, the input structures 22 (such as a keyboard and/or touchpad) may be used to interact with the computer 10A, such as to start, control, or operate a GUI or applications running on computer 10A. For example, a keyboard and/or touchpad may permit a user to navigate a user interface or application interface displayed on the electronic display 18.

FIG. 3 depicts a front view of a handheld device 10B, which represents one embodiment of the electronic device 10. The handheld device 10B may represent, for example, a portable phone, a media player, a personal data organizer, a handheld game platform, or any combination of such devices. By way of example, the handheld device 10B may be a model of an iPod® or iPhone® available from Apple Inc. of Cupertino, Calif. The handheld device 10B may include an enclosure 36 to protect interior components from physical damage and to shield them from electromagnetic interference. The enclosure 36 may surround the electronic display 18. The I/O interfaces 24 may open through the enclosure 36 and may include, for example, an I/O port for a hard-wired connection for charging and/or content manipulation using a standard connector and protocol, such as the Lightning connector provided by Apple Inc., a universal service bus (USB), or other similar connector and protocol.

User input structures 22, in combination with the electronic display 18, may permit a user to control the handheld device 10B. For example, the input structures 22 may activate or deactivate the handheld device 10B, navigate user interface to a home screen, a user-configurable application screen, and/or activate a voice-recognition feature of the handheld device 10B. Other input structures 22 may provide volume control, or may toggle between vibrate and ring modes. The input structures 22 may also include a microphone may obtain a user's voice for various voice-related features, and a speaker may enable audio playback and/or certain phone capabilities. The input structures 22 may also include a headphone input may provide a connection to external speakers and/or headphones.

FIG. 4 depicts a front view of another handheld device 10C, which represents another embodiment of the electronic device 10. The handheld device 10C may represent, for example, a tablet computer or portable computing device. By way of example, the handheld device 10C may be a tablet-sized embodiment of the electronic device 10, which may be, for example, a model of an iPad® available from Apple Inc. of Cupertino, Calif.

Turning to FIG. 5, a computer 10D may represent another embodiment of the electronic device 10 of FIG. 1. The computer 10D may be any computer, such as a desktop computer, a server, or a notebook computer, but may also be a standalone media player or video gaming machine. By way of example, the computer 10D may be an iMac®, a MacBook®, or other similar device by Apple Inc. It should be noted that the computer 10D may also represent a personal computer (PC) by another manufacturer. A similar enclosure 36 may be provided to protect and enclose internal components of the computer 10D such as the electronic display 18. In certain embodiments, a user of the computer 10D may interact with the computer 10D using various peripheral input devices, such as input structures 22A or 22B (e.g., keyboard and mouse), which may connect to the computer 10D.

Similarly, FIG. 6 depicts a wearable electronic device 10E representing another embodiment of the electronic device 10 of FIG. 1 that may be configured to operate using the techniques described herein. By way of example, the wearable electronic device 10E, which may include a wristband 43, may be an Apple Watch® by Apple, Inc. However, in other embodiments, the wearable electronic device 10E may include any wearable electronic device such as, for example, a wearable exercise monitoring device (e.g., pedometer, accelerometer, heart rate monitor), or other device by another manufacturer. The electronic display 18 of the wearable electronic device 10E may include a touch screen (e.g., LCD, OLED display, active-matrix organic light emitting diode (AMOLED) display, and so forth), as well as input structures 22, which may permit users to interact with a user interface of the wearable electronic device 10E.

These electronic devices 10 depicted in FIG. 1 through FIG. 6 are example embodiments of a retail computing device, a back end computing device, a new purchased device, and an electronic services service provider. These electronic devices 10 may be used in any combination to facilitate a customer-initiated purchase of a new device. For example, the computer 10A may be used in a physical retail store to facilitate the customer-initiated purchase of the wearable electronic device 10E, where upon completion of the purchase of the wearable electronic device 10E, the computer 10A, operating as the retail computing device, may transmit a purchase payload to the computer 10D, operating as the back end computing device, to complete a purchase of one or more electronic services at a later time.

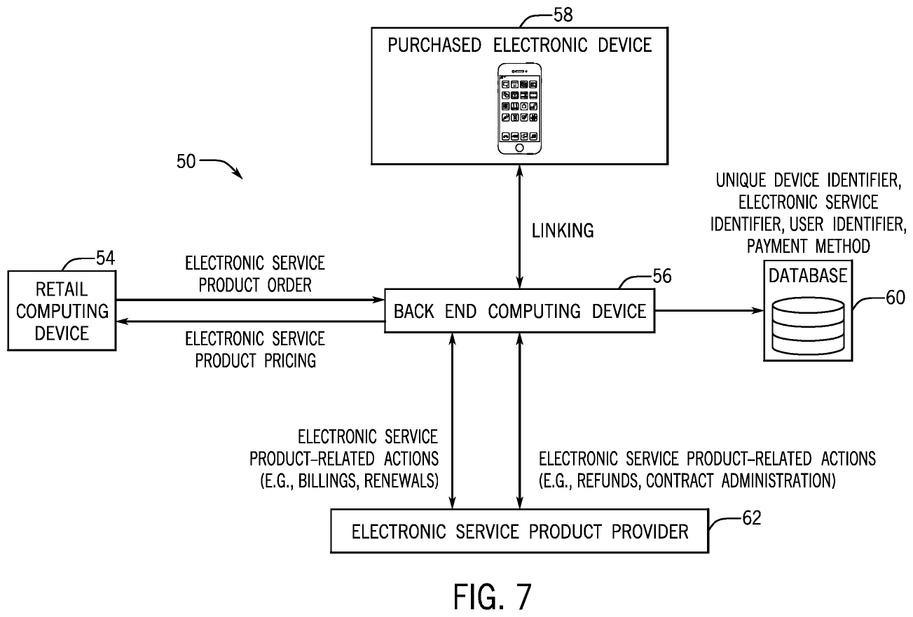

To help explain, FIG. 7 is a block diagram of a system 50 to complete a customer-initiated purchase of an electronic device. In the depicted example, a retail computing device 54 initiates an electronic service product order for transmission to a back end computing device 56 and the back end computing device 56 transmits electronic service product pricing to the retail computing device 54. As may be appreciated, the electronic service product order may be initiated by a user of the retail computing device 54, for example, through a customer making a purchase in a physical store (e.g., where a check-out electronic device is the retail computing device 54), through a user facilitating a purchase on behalf of a customer in a physical store, or through a customer making a purchase in a digital store (e.g., where a personal electronic device hosting a web-browser interface is the retail computing device 54). The electronic service product pricing may be transmitted to the retail computing device 54 in response to the electronic service product order, indications of products to be purchased, as part of routine pricing updates, or any suitable trigger event. For example, a user of the retail computing device 54 may indicate an order of a computer 10A. In response to the indication of the order, the back end computing device 58 may transmit electronic service product pricing specific to the computer 10A as a way to provide order-relevant product offerings. Based on the finally selected service products and electronic devices, a finally-transmitted electronic service product order may be transmitted to the back end computing device 56 to indicate the electronic service product ordered and the purchased electronic device (e.g., a purchased electronic device 58). In alternative embodiments, the pricing may be retained locally at the retail computing device 54 without accessing pricing from the back end computing device 56.

The electronic service product order may include information related to a particular purchased electronic device, a payment account used, a particular purchased service product, or the like. For example, the final electronic service product order may include indications of a unique device identifier (e.g., serial number, media access control (MAC) address), an electronic service identifier (e.g., electronic service serial number, service name, media access control (MAC) address), a user identifier (e.g., username, email, fingerprint, voice profile, Touch ID, or other biographical information related to a user to be linked with the electronic device and electronic service product), a payment method (e.g., credit or debit account information), or the like. As may be appreciated, the electronic service product order may include some or all of the above-listed information, for example, the electronic service product order may include a unique device identifier, an electronic service identifier, a payment method, but not a user identifier.

In response to receiving the electronic service product order, the back end computing device 56 may store some or all of the information of the electronic service product order into a database 60. The database 60 may be hosted in a server, may represent multiple memory components, and/or may be accessible by the back end computing device 56 through physical couplings or through wireless couplings. The back end computing device 56 may also link the electronic service product ordered to the purchased electronic device 58. This linking may happen in response to a user powering on the purchased electronic device, such as to cause the purchased electronic device to perform a power up operations, or other suitable qualifying event, to link the unique device identifier to the electronic service identifier. In some embodiments, at the time of linking, the back end computing device 56 may also facilitate the linking of a user identifier (e.g., user account indicated by a username, email address, or the like) with the unique device identifier and the electronic service identifier. In addition, in some embodiments, the payment method is not charged for the electronic service product until the electronic service product is linked with the electronic device. This may facilitate electronic service product activation and may be initiated in response to a qualifying event.

The back end computing device manages interactions between the purchased electronic device 58 and an electronic service product provider 62. The electronic service product provider 62 is any suitable computing or networking device that provides infrastructure for the electronic service product ordered via the retail computing device 54. For example, an electronic service (e.g., digital content service subscription or an insurance product) may be purchased as an electronic service product, and thus the electronic service product provider 62 may transmit user data and/or electronic service product data to the back end computing device 56 for transmission to the purchased electronic device 58 to facilitate interaction with the digital content service subscription or the insurance product. As such, the electronic service product provider 62 may receive electronic service product related actions, such as refund requests, contract administration requests (e.g., questions, account changes), or the like, from the back end computing device 56. Similarly, the electronic service product provider 62 may transmit electronic service product-related actions, such as billings, indications of service renewals, or the like, to the back end computing device 56. In this way, the electronic service product provider 62 may activate the electronic service product in response to a control signal transmitted from the back end computing device 56 based at least in part on a qualifying event occurring. After linking the electronic service product provider 62 with the purchased electronic device 58, the electronic service product provider 62 may interface with the purchased electronic device 58 without use of the back end computing device 56 to provide the linked electronic service by the electronic service product provider 62 to the purchased electronic device 58.

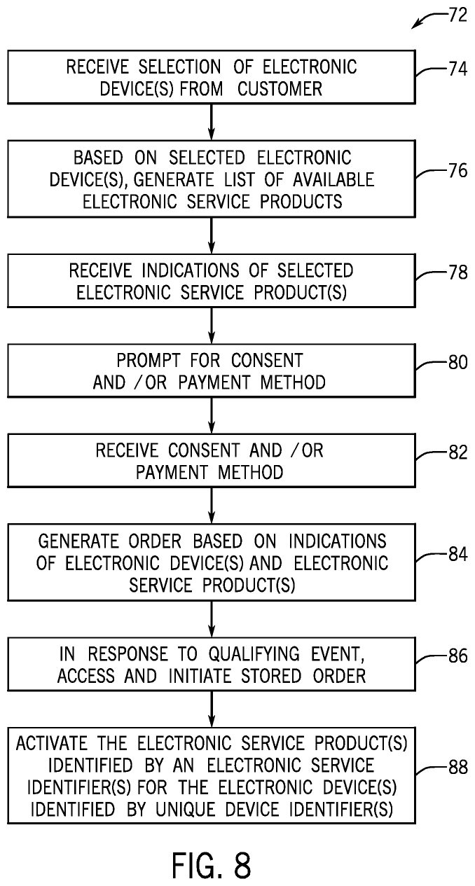

FIG. 8 is a flowchart of a process 72 for activating a subscription associated with the customer-initiated purchase described in FIG. 7. Although the process 72 is described below as being performed by the back end computing device 56, it should be understood that the process 72 may be performed by any suitable processor or computing device to facilitate activation of an electronic service product, associated with a customer-initiated purchase. Moreover, although the following description of the process 72 is described in a particular order, it should be noted that the process 72 may be performed in any suitable order.

At block 74, the back end computing device 56 receives selection of one or more electronic devices 10 from customer. The selection may be received, for example, via the retail computing device 54, such as in a physical store or in a digital (e.g., online) store. For ease of discussion, the one or more electronic devices selected are referred to as a selected electronic device 10 thus it should be understood that any of the following blocks may be repeated or performed multiple times for multiple selections of electronic devices. The selected electronic device 10 is considered the purchased electronic device 58 after the customer purchases the selected electronic device 10. After receiving the selection of the electronic device 10 from the customer (e.g., sometimes via the user of the retail computing device 54), the retail computing device 54 transmits the selection to the back end computing device 56.

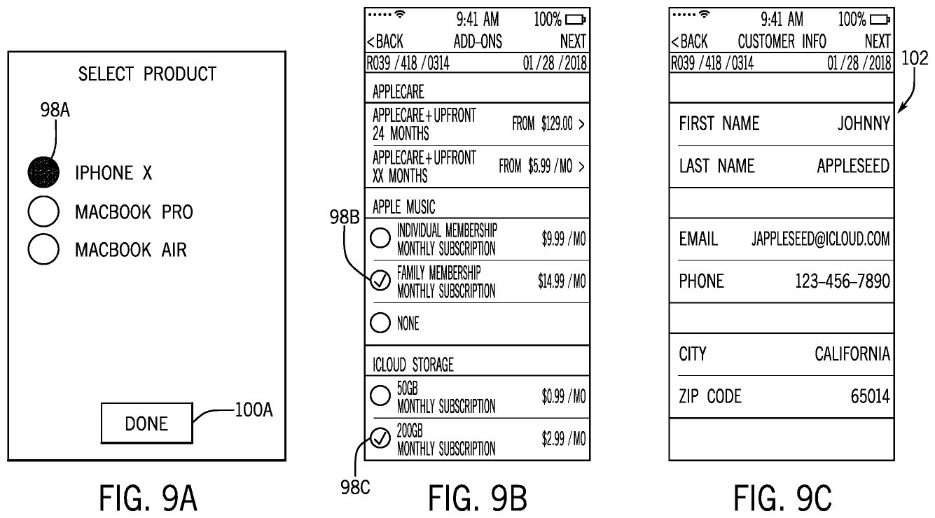

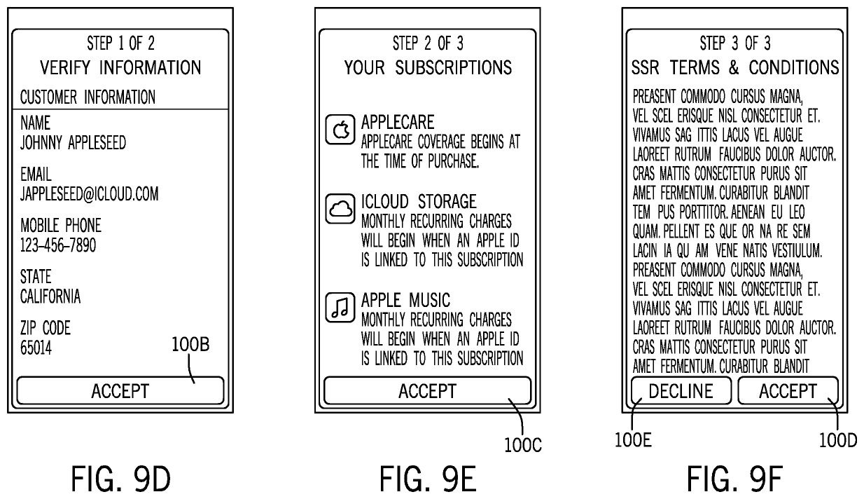

Referring briefly to FIG. 9A, FIG. 9A is an illustration of a graphical user interface, presented to a user, indicating a selection of an electronic device 10. A user of the retail computing device 54 has selected (e.g., via an enabled radio button 98A) an electronic device 10 based on a customer selection. This selection may be performed in physical store by a user of the retail computing device 54 on behalf of a customer shopping in the physical store. A similar graphical user interface may be presented to a customer and user of an online store initiating a purchase. To complete the selection, a user of the retail computing device 54 may actuate a digital button 100A (e.g., “done” button) to transmit the selection to the back end computing device 56. In some embodiments, the user may use audio commands (e.g., voice commands) to interact with the retail computing device 54, or any other suitable electronic device described herein, to actuate the digital button 100A or proceed with a selection.

Returning to FIG. 8, in response to receiving the selection, at block 76, the back end computing device 56 generates a list of available electronic service products based on the selected electronic device 10. For example, a user of the retail computing device 54 may indicate in an electronic service product order that they want to order the handheld device 10B. In response to receiving the selection, the back end computing device 56 may generate an electronic service product pricing list specific to the handheld device 10B and thus may provide order-relevant electronic service product offerings to the retail computing device 54. The electronic service product pricing list may include information related to relevant subscriptions and electronic services to the selected electronic device 10 such as pricing, subscription details or descriptions, electronic service details or descriptions, subscription or electronic service options (e.g., single membership or family membership), or the like. This personalized offerings list may improve user experience with purchasing electronic service products may making selecting electronic service products more efficient and simpler for the user.

At block 78, the back end computing device 56 may receive indications of one or more selected electronic service products from the retail computing device 54. In response to receiving the generated list of available electronic service products, the retail computing device 54 may present the user with a graphical user interface depicting the various electronic service products and available options for each electronic service product. Thus, after the user or customer (acting as the user via online store) selects the one or more electronic service products and options, the retail computing device 54 may transmit the selections to the back end computing device 56.

Referring briefly to FIG. 9B, FIG. 9B is an illustration of a selection of an electronic service product and options. A user of the retail computing device 54 has selected an electronic service product (e.g., AppleCare+) and various options (e.g., Family membership vs Individual membership or None, 50 gigabyte (GB) vs 200 GB) via enabled radio buttons 98 (e.g., 98B, 98C) an electronic device 10 based on a customer selection. This selection may be performed in physical store by a user of the retail computing device 54 on behalf of a customer disposed in the physical store. A similar graphical user interface may be presented to a customer and user of an online store initiating a purchase. To complete the selection, a user of the retail computing device 54 may actuate a digital button (e.g., “done” button), not pictured, to transmit the selection to the back end computing device 56.

Returning to FIG. 8, after receiving the selections, at block 80, the back end computing device 56 may prompt for consent and/or a payment method via the retail computing device 54. The consent may be associated with the electronic service product, that is, various electronic services products are associated with various service agreements for a user to agree with (e.g., consent to) before they may use an electronic service product. The service agreement may be a contract or terms of use of the electronic service product. In this way, when a customer gives their consent, they agree with the service agreement. In addition, a payment may be associated with completing a purchase of the electronic device 10 and/or the electronic service product. To prompt for consent and/or a payment method, the back end computing device 56 may transmit a command to the retail computing device 54 to generate a suitable graphical user interface, or the back end computing device 56 may generate a graphical user interface and transmit image data associated with presenting the generated graphical user interface to the retail computing device 54.

At block 82, the back end computing device 56 may receive the consent and/or the payment method associated with the customer from the retail computing device 54. The consent and/or payment method may be provided to the back end computing device 56 as information or data corresponding to a user input into the retail computing device 54. For example, consent may be transmitted to the back end computing device 56 as data corresponding to “yes” or a consent indication of “yes” (e.g., a 1 for “yes” and a 0 for “no”). If the back end computing device 56 does not receive consent or a payment method from the retail computing device 54, the electronic device and the electronic service product order may not be processed.

Referring to FIG. 9C-F, FIG. 9C is an illustration of a graphical user interface used to prompt a user to enter biographical information (e.g., biographical data) corresponding to a customer initiating a purchase. FIG. 9D is an illustration of a graphical user interface used to prompt the user to verify with the customer the entered biographical information. FIG. 9E is an illustration of a graphical user interface used to prompt the user to receive consent from the customer for accepting and confirming the electronic service products to be purchased. FIG. 9F is an illustration of a graphical user interface used to prompt the user to receive consent from the customer for processing the order and agreeing to terms and conditions, or service agreements associated with one or more electronic service products. Each of these screens present to the user may include one or more data fields 102 that permit the user to enter data corresponding to the customer. Each of these screens also may present to the user digital buttons 100 (e.g., 100B, 100C, 100D, 100E) use to provide agreement, to decline, and/or to confirm various information presented to the user.

Returning to FIG. 8, in response to receiving consent and/or a payment method from the retail computing device 54, at block 84, the back end computing device 56 may generate an order based on the previous selections of the one or more electronic devices 10 and one or more electronic service products for customer purchase. The order may include information associating the unique device identifier of the purchased electronic device 58 to the purchased electronic service product. The order, in some embodiments, may also associate biographical information (e.g., as entered in the data fields 102 of FIG. 9C) and/or a payment method with the unique device identifier and/or the purchased electronic service product. For instances where the provided payment method is valid, the back end computing device 56 may retain the final and valid payment method used to purchase the selected electronic device 10. In some embodiments, some or all of the generated order may be transmitted to the retail computing device 54 to be given to the customer (e.g., as a printed or emailed receipt) or may be transmitted to an electronic device 10 (e.g., an emailed receipt). It should be noted that the retail computing device 54 may transmit receipts to the customer based on the selections received by the retail computing device 54. The back end computing device 56 may save (e.g., preserve, retain) the order in the database 60, or any suitable memory store. After generating the order, in some embodiments, the back end computing device 56 may wait for a qualifying event to trigger activation of the electronic service product (e.g., via enabling a control signal or other suitable triggering indication).

Thus, in response to the qualifying event, at block 86, the back end computing device 56 may access and initiate fulfillment of the stored order. The back end computing device 56 may process the payment method associated with the stored order to initiate a purchase of the electronic service product. In some embodiments, the purchase may not be completed until a user of the purchased electronic device 58 enters one or more user identifiers (e.g., username, password, email address) to prompt linking of the purchased electronic device 58 with a digital profile of the user.

After completing the purchase and verifying the stored payment method was valid (e.g., able to be used to complete the transaction without error), at block 88, the back end computing device 56 triggers activation of the electronic service product identified by electronic service identifiers (e.g., included in the order) for use on or with the purchased electronic device 58 identified by unique device identifiers (e.g., as indicated in the order). In response to the qualifying event, the back end computing device may transmit a control signal or suitable activation trigger to the electronic service product provider 62 to cause activation of the electronic service product on the purchased electronic device 58. Thus, in response to the qualifying event, the payment method is processed and the electronic service product is installed and/or activated on the purchased electronic device 58.

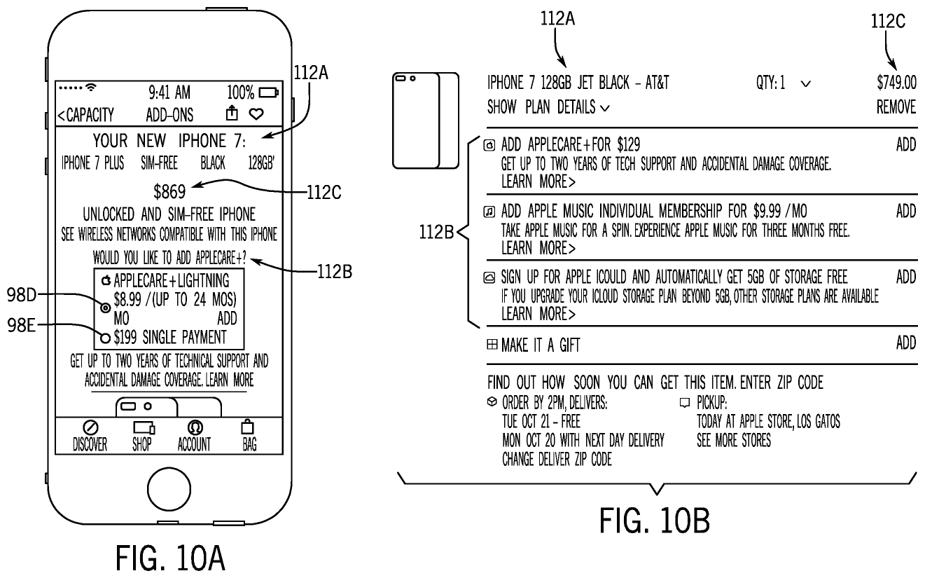

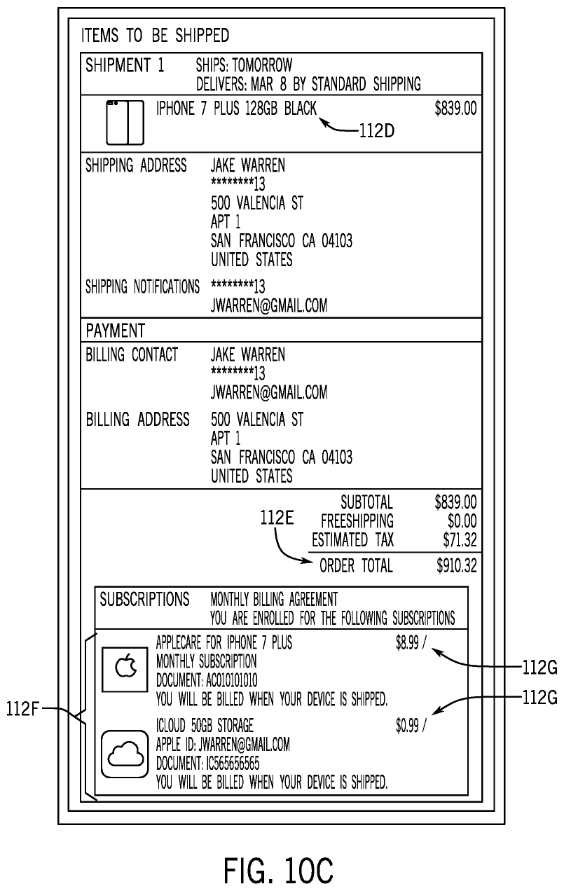

Referring now to FIGS. 10A-C, FIGS. 10A-C are illustrations depicting the customer-initiated purchase described with FIG. 7 and the process 72 from the perspective of a retail computing device on a mobile platform. Thus, FIG. 10A and FIG. 10B are illustrations of example graphical user interfaces of a mobile platform indicating to a user the selected electronic devices (e.g., indication 112A), a generated list of available electronic service products (e.g., indication 112B) and associated pricing (e.g., indication 112C) that may dynamically change in response to user selection of electronic service products via radio buttons 98 (e.g., 98D, 98E). FIG. 10C is an illustration of a graphical user interface of a mobile platform depicting an order transmitted to the customer in response to completing a customer-initiated purchase. This order may include information to communicate to the customer the one or more electronic devices 10 purchased (indication 112D), an amount charged to the provided payment method (indication 112E), the one or more electronic service products the customer agreed to purchase (indication 112F), and an amount that is to be charge to the provided payment method at a future time (indication 112G). It should be understood that this is merely one example of an order and, in some embodiments, more or less information may be included in the order for storage by the back end computing device 56 or for presentation to the customer.

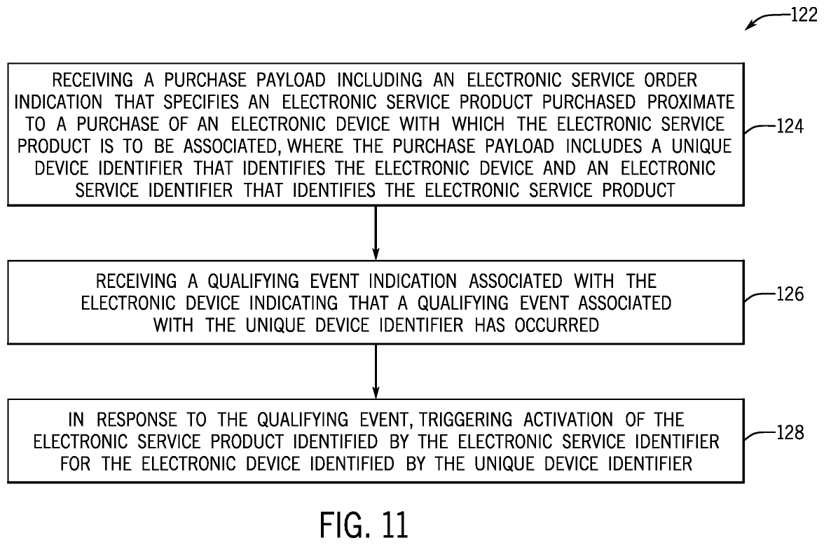

Continuing on to a more detailed discussion of order fulfillment, FIG. 11 is a flowchart of a process 122 for processing payment methods and activating electronic service products in response to the customer-initiated purchase of FIG. 7. Although the process 122 is described below as being performed by the back end computing device 56, it should be understood that the process 122 may be performed by any suitable processor or computing device to activate a subscription, also referred to as an electronic service product, associated with a customer-initiated purchase. Moreover, although the following description of the process 122 is described in a particular order, it should be noted that the process 122 may be performed in any suitable order.

At block 124, the back end computing device 56 may receive a purchase payload including an electronic service order indication that specifies an electronic service product purchased proximate to a purchase (e.g., with regards to time) of an electronic device with which the electronic service product is to be associated, where the purchase payload includes a unique device identifier that identifies the electronic device and an electronic service identifier that identifies the electronic service product. The purchase payload may be generated in response to the retail computing device 54 facilitating completion of a purchase. The purchase payload is a data packet transmitted from the retail computing device 54 to the back end computing device 56 to summarize certain transaction and customer-purchase details, such as the electronic device 10 purchased (e.g., the purchased electronic device 58) and the electronic service products purchased, in addition to consents and/or payment methods provided by the customer.

In some embodiments, at block 126, the back end computing device 56 may receive a control indicating or detect a qualifying event associated with the purchased electronic device 58. The unique device identifier (e.g., serial number) is associated with the purchased electronic device 58 and thus actions, such as, qualifying events, linked to the unique device identifier may be associated with the purchased electronic device 58. A qualifying event may include a user powering on the purchased electronic device 58, the user completing an initial set-up of the purchased electronic device 58 (where at completion an indication of the initial set-up may be transmitted to the back end computing device 56), the user selecting or opening an application (for example, an application corresponding to the purchased electronic service product) for use thereby causing transmission of an indication corresponding to an initial request for use of the electronic service product, the user accessing digital content for use via the electronic service product thereby causing transmission of an indication corresponding to an initial request for use of the electronic service product, a shipment of the purchased electronic device being completed, arrival of a particular calendar date corresponding to a date when a shipment is expected to be completed (e.g., provided to the back end computing device 56 by a third party shipping service or other suitable service provider), a pre-determined amount of time passing, or the like.

In response to the qualifying event, at block 128, the back end computing device 56 may activate the electronic service product identified by the electronic service identifier for the purchased electronic device 58 identified by the unique device identifier. The back end computing device 56 may query the database 60 to determine relevant electronic service products based on the unique device identifier of the purchased electronic device 58 and the qualifying event, where “relevant” refers to electronic service products agreed to be purchased for use on the purchased electronic device 58. After determining relevant electronic service products, the back end computing device 56 may facilitate the activation and linking of a digital profile corresponding to the user, the purchased electronic device 58, and the purchased electronic service product. After linking, the back end computing device 56 may update data stored, such as, in the database 60, to indicate that the user is associated with the purchased electronic device 58. The back end computing device 56 may also save the payment method used to pay for the electronic service product by the user with the digital profile of the user. At the end of the process 122, the purchased electronic device 58 may have paid-access to the electronic service product until an end of a contract term (e.g., a time paid for, a subscription period, until a renewal date).

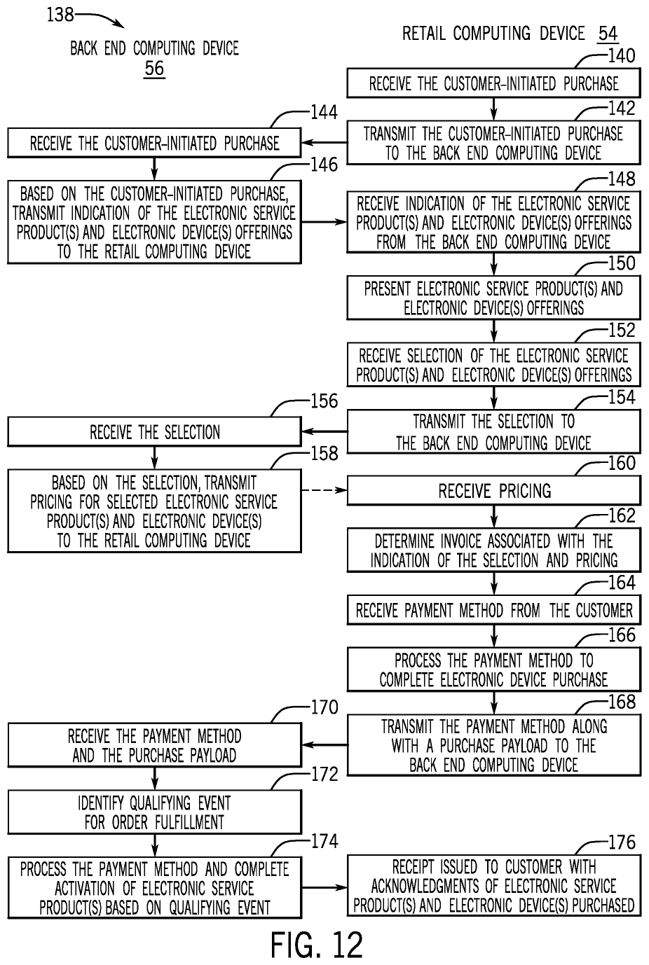

Continuing onto FIG. 12, FIG. 12 is a flowchart of a process 138 performed by the retail computing device 54 and the back end computing device 56 for processing payment methods and activating electronic service products associated with the customer-initiated purchase of FIG. 7. Although the process 138 is described below as being performed by the back end computing device 56 and the retail computing device 54, it should be understood that the process 138 may be performed by any suitable processor or computing device to activate an electronic service product, associated with a customer-initiated purchase. Moreover, although the following description of the process 138 is described in a particular order, it should be noted that the process 138 may be performed in any suitable order.

At block 140, the retail computing device 54 may receive a customer-initiated purchase or an indication of the customer-initiated purchase. Many different avenues for placing an order may be present, including, but not limited to, a customer accessing an online store (e.g., a software/application-based store, web-based store) or proceeding with a checkout event in a physical store. For the physical store example, the customer may have already selected a physical electronic device 10 product offering when the retail computing device 54 receives the customer-initiated purchase (e.g., a customer physically transporting an item for purchase at the retail computing device 54). However, a user of the retail computing device 54 may proceed through electronic device 10 selection as described below (and thus, the retail computing device 54 may still present and receive selection of electronic device 10 offerings).

At block 142, the retail computing device 54 transmits the customer-initiated purchase to the back end computing device 56 where the customer-initiated purchase includes an indication of the selected electronic device 10. At block 144, the back end computing device 56 receives the customer initiated purchase and, at block 146, generates and transmits an indication of electronic service product and electronic device 10 offerings to the retail computing device 54 based at least in part on the customer-initiated purchase.

The retail computing device 54, at block 148, may receive the indication of the electronic service product and the electronic device 10 offerings. At block 150, the retail computing device 54 may present the electronic service product offerings to the user. To do so, the retail computing device 54 may update a graphical user interface to depict one or more indications of the electronic service product offerings to the user (e.g., indications 112B of FIG. 9A-B). In some embodiments, the retail computing device 54 presents the electronic device offerings to the user before the electronic service product offerings such that the electronic service product offerings are presented in response to selected electronic device offerings as order-relevant electronic service product offerings.

After presenting the electronic service product and the electronic device 10 product offerings to the user, at block 152, the retail computing device 54 may receive a selection of respective electronic service products and the electronic device 10 products. The selection indicates which product offerings the customer wishes to purchase. The selection is an input from a user of the retail computing device 54 (e.g., a user inputting on behalf of the customer that initiated the purchase, the customer as a user that initiated the purchase).

At block 154, the retail computing device 54 may transmit the selection to the back end computing device 56, and at block 156, the back end computing device 56 may receive the selection of the respective electronic service products and the electronic device 10 products. Based on the selection, the back end computing device 56 may, at block 158, determine and transmit pricing for the selected electronic service products and for the selected electronic devices 10 to the retail computing device 54. The back end computing device 56 may reference information stored in the database 60 and/or may access information maintained by the electronic service product provider 62 to determine an amount to charge the customer for the selected products. At block 160, the retail computing device 54 may receive the pricing from the back end computing device 56, and at block 162, use the pricing in addition to the selected product offerings to determine (e.g., develop, generate) an invoice. The invoice may resemble the graphical user interface of FIG. 9B, a printed receipt, an emailed receipt, or the like. After the invoice is presented to the customer via the retail computing device 54, at block 164, the retail computing device 54 receives a payment method from the customer. The payment method is used by the customer to pay the invoice to complete the purchase.

At block 166, the retail computing device 54 processes the payment method to complete the purchase of the selected electronic device 10. Upon verification and completion of the purchase, the selected electronic device 10 becomes the purchased electronic device 58. In some embodiments, the retail computing device 54 communicates with the back end computing device 565 for processing and verifying the payment method, however in some embodiments, the retail computing device 54 communicates with a third-party software (e.g., PayPal, banking software) to process and verify the payment method. In response to completing the purchase, at block 168, the retail computing device 54 transmits the payment method along with a purchase payload to the back end computing device 56.

At block 170, the back end computing device 56 receives the payment method and the purchase payload. The purchase payload may include information related to the customer, the payment method, the purchased electronic device 58, the selected electronic service products, or the like. In this way, the purchase payload may at least include a unique device identifier and electronic service identifier such that the selected electronic service product and the purchased electronic device 58 are associated in a memory (e.g., the database 60) accessible by the back end computing device 56.

In some embodiments, when the purchase payload is received by the back end computing device 56, the purchase of the selected electronic device has been processed but the purchase of the electronic service product is delayed until the back end computing device 56 identifies a qualifying event, such as at block 172, or receives indication of a qualifying event (e.g., via a control signal transmitted from the purchased electronic device 58). The qualifying event, as described earlier, may be any suitable event that prompts the back end computing device 56 to process payment for an electronic service product. A qualifying event indication may be associated with the electronic device and may indicate that a qualifying event associated with the unique device identifier has occurred. In alternative embodiments, the purchase of the electronic service product may be processed at the time of purchase of the selected electronic device, while the activation of the electronic service may not be processed (e.g., completed) until a qualifying event occurs (e.g., at a different time).

In response to receiving the qualifying event or to receiving the qualifying event indication, the back end computing device 56, at block 174, processes the payment method saved for the purchased electronic device 58 and/or completes activation of the selected electronic service products based on the qualifying event. In this way, the back end computing device 56 may reference the database 60, determine based on the qualifying event which electronic service products to activate, and further verify that the particular purchased electronic device 58 is qualified to have the electronic service products installed and/or activated (e.g., having suitable consents, permissions, settings, and/or payments). Thus, the qualifying event may correspond to a unique device identifier and an electronic service identifier to identify the purchased electronic device 58 and the purchased electronic service product to be associated with the purchased electronic device 58 to facilitate the activation of the electronic service product.

After the activation of the electronic service product, at block 176, the back end computing device 56 may issue a receipt to the customer, or may signal to the retail computing device 54 to cause the issuing of the receipt to the customer. The receipt may include acknowledgements of the purchased electronic device 58 and the purchased electronic service product. At this point, the electronic service product is purchased and activated on the purchased electronic service product.

In some embodiments, the electronic service product is a subscription service that is renewed on regular time intervals. But, in some embodiments, the electronic service product is a one-time purchase service that may or may not expire after a particular time interval or service period. For example, a music subscription service may be an electronic service product that is renewed each month, while a news subscription service may be an electronic service product that is renewed each year. In addition, an insurance product may be an electronic service product that is not renewable and expires after a year, or a period of time corresponding to the electronic service product purchased. It should be noted that although the process 138 may have been described in terms of one electronic service product and one purchased electronic device, a transaction may correspond to a purchase of multiple electronic service products and multiple electronic devices, or any combination thereof.

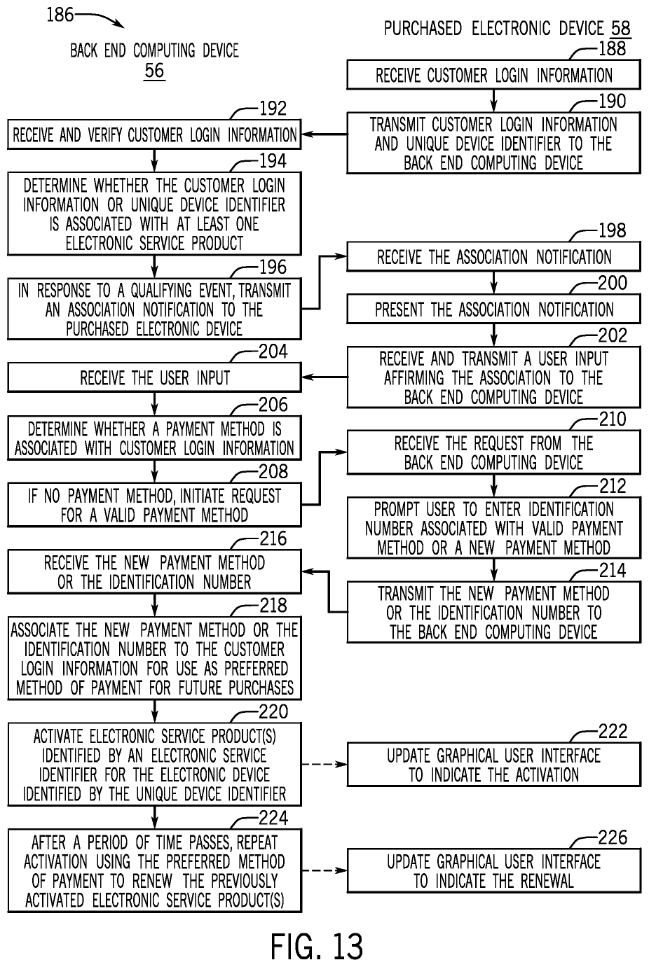

Turning now to a discussion of the interactions between the back end computing device 56 and the purchased electronic device 58, FIG. 13 is a flowchart of a process 186 performed by the purchased electronic device 58 and the back end computing device 56 for activating and renewing electronic services associated with the customer-initiated purchase of FIG. 7. Although the process 186 is described below as being performed by the back end computing device 56 and the purchased electronic device 58, it should be understood that the process 186 may be performed by any suitable processor or computing device to activate a subscription, also referred to as an electronic service product, associated with a customer-initiated purchase. Moreover, although the following description of the process 186 is described in a particular order, it should be noted that the process 186 may be performed in any suitable order.

At block 188, the purchased electronic device 58 may receive customer login information. The customer login information may be inputted by a user via one or more input structures. The purchased electronic device 58, at block 190, may transmit the customer login information and/or a unique device identifier to the back end computing device 56. The unique device identifier corresponds to the purchased electronic device 58 the customer login information was inputted on. The back end computing device 56, in response to receiving the data, may associate the unique device identifier with the customer login information in the database 60 to establish a link between that particular user and the purchased electronic device 58. This link may be used to enhance user experiences, such as through automatic option population and tailoring presentation of digital content.

At block 192, the back end computing device 56 receives the customer login information and the unique device identifier. The back end computing device 56 may verify the customer login information after receipt. In response to the customer login information being valid, as described above, the back end computing device 56 may associate the customer login information with the purchased electronic device 58 (e.g., via the unique device identifier) in the database 60. After verification and association, the back end computing device 56, at block 194, determines whether the customer login information or the unique device identifier is associated with at least one electronic service product. The association between an electronic service product and the unique device identifier or the customer login information may be made at a time of purchase of the purchased electronic device 58, such as when the customer provides consent to purchase a particular electronic service product at a later time. Determining the at least one electronic service products associated with the user (e.g., either through the purchased electronic device 10 and/or through the customer login information) defines the qualifying events that may trigger activation of the electronic service product.

In response to a qualifying event (e.g., as defined through the particular electronic service product to be purchased by the user), at block 196, the back end computing device 56 transmits an association notification (e.g., an indication of the association) to the purchased electronic device 58. The association notification may be any suitable flag, signal, data byte or bit, or the like to indication association of the electronic service product to the purchased electronic device 58. At block 198, the purchased electronic device 58 receives the association notification and, at block 200, the purchased electronic device 58 presents the association notification to the user. In some embodiments, the purchased electronic device 58 generates and presents a graphical user interface in response to the association notification. The association notification may request a user confirm the association via a user input (e.g., selecting a button, providing an electronic signature, or the like). In response to receiving a user confirmation of the association, at block 202, the purchased electronic device 58 transmits the user input affirming the association to the back end computing device 56. At block 204, the back end computing device 56 receives the user input. The back end computing device 56 may associate the user input with the customer login information and/or the purchased electronic device 58 in the database 60.

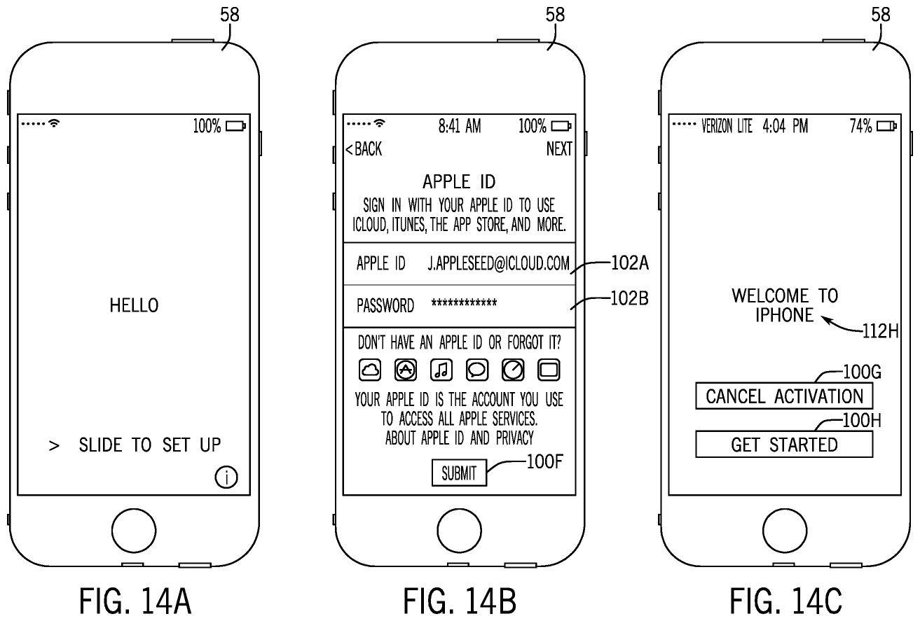

Referring briefly to FIG. 14A-C, FIG. 14A is an illustration of a graphical user interface presenting a welcome message to a user. The user may be prompted by the graphical user interface to interact or otherwise confirm to set-up the purchased electronic device 58 (e.g., “slide to set-up”). In response to completing the prompt in a substantially suitable manner, an indication of initial set-up may be transmitted from the purchased electronic device 58 to the back end computing device 56. The indication of initial set up may begin or facilitate linking the user, an electronic service product, and the purchased electronic device 58. FIG. 14B is an illustration of a graphical user interface prompting the user to enter customer login information into data fields 102 (e.g., 102A, 102B) and submit via actuation of a digital button 100F. The graphical user interface also indicates to the user an example of software applications that may reference the customer login information. This may enhance the user experience for the user. FIG. 14C is an illustration of a graphical user interface presenting the association notification to the user. By reading the indication 112H, the user is able to receive confirmation that the customer login information was suitably linked with the purchased electronic device 58. The user, after reading the indication 112H, may actuate a digital button 100H to confirm the association or a digital button 100G to cancel the association.

Returning to FIG. 13, at block 206, the back end computing device 56 may determine whether a payment method is associated with the customer login information. For example, the back end computing device 56 may refer to the database 60 to determine if the user has previously provided a payment method to the back end computing device 56. If a payment method exists for the customer login information, at block 220, the back end computing device 56 may use that payment method in the database 60 as the payment method to complete a transaction associated with a purchase of the electronic service product.

However, if no payment method exists for the customer login information, at block 208, the back end computing device 56 initiates a request for a valid payment method. This request may be transmitted to the purchased electronic device 58 at block 210. In response to the request, at block 212, the purchased electronic device 58 may prompt the user to re-enter a valid payment method (e.g., one or more account identification numbers) or to enter a new, valid payment method. At block 214, the purchased electronic device 58 transmits the new payment method to the back end computing device 56 for verification.

At block 216, the back end computing device 56 receives the new payment method or identification number, and verifies that the payment method is now valid. If the payment method is not valid, the back end computing device 56 may continue to repeat the prompting of the user for a valid payment method and may continue to verify any entered payment method until receiving a valid payment method. After receiving a valid payment method, at block 218, the back end computing device 56 may associate the new payment method or the identification number to the customer login information. The payment method for the customer login information may be saved in the database 60 and used as a preferred method of payment for future purchases or service period renewals. In some embodiments, the preferred method of payment is automatically populated into suitable fields during a purchase process for the user logging in with the customer login information as a way to enhance and improve the user experience.

At block 220, the back end computing device 56 uses the payment method to activate the one or more electronic service products with the purchased electronic device 58. The activation may include processing the purchase associated with the one or more electronic service products and the payment method, such that the user associated with the customer login information is charged for the electronic service products at the time of activation (e.g., rather than at the time consent was given to purchase the electronic service product).

In some embodiments, at block 212, the back end computing device 56 may transmit a completion notification to the purchased electronic device 58 to cause the purchased electronic device 58 to indicate the activation to the user. The purchased electronic device 58 may update a graphical user interface presented to the user to indicate the association between the electronic service product and the purchased electronic device 58 to the user.

In addition, in some embodiments, at block 224, the back end computing device 56 may repeat the activation of the electronic service product using the preferred method of payment to renew the previously activated electronic service product(s). At block 226, the purchased electronic device 58 may receive a renewal notification from the back end computing device 56 and may update a graphical user interface to communicate the renewal to the user. This automatic renewal operational scheme may be particular desirable for embodiments of the electronic service products that utilize renewal operational schemes and/or subscriptions. For example, a music subscription electronic service product, a digital content electronic service product, or the like may use an automated renewal operational scheme.

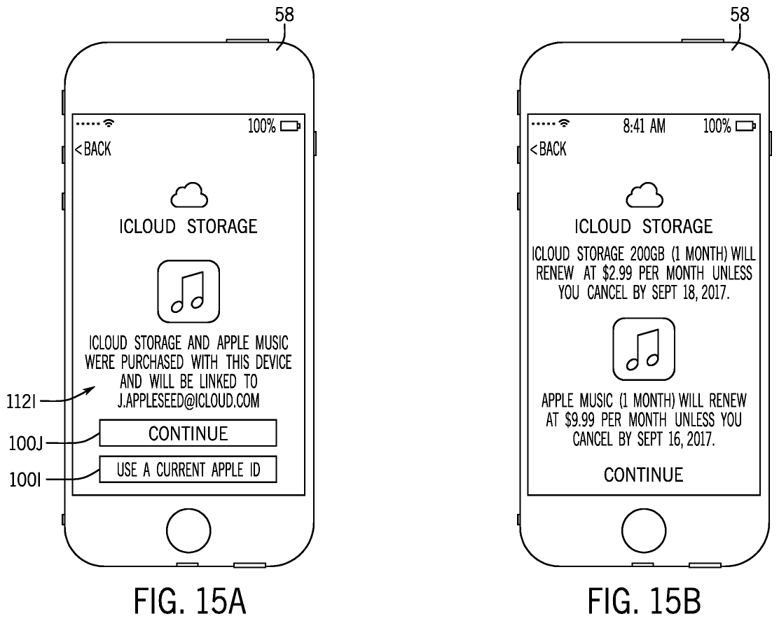

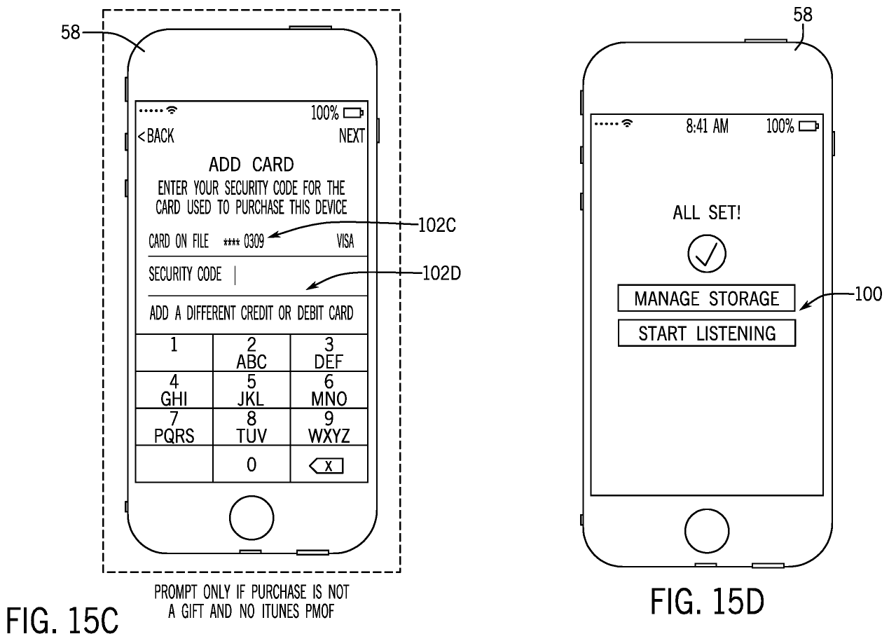

As described above (e.g., at block 192 and the block 194 of the process 186), the back end computing device 56 may determine whether the customer login information or unique device identifier is associated with at least one electronic service product. An example result of the determination is depicted in FIG. 15A, wherein FIG. 15A is an illustration of a graphical user interface prompting the user to continue with processing payment and activating two electronic service products purchased alongside (e.g., proximate) the purchased electronic device 58 (e.g., iCloud Storage and Apple Music). The graphical user interface also depicts an embodiment of the association notification. In this embodiment, the user is notified of the association between the customer login information and the purchased electronic device via indication 112I (e.g., “will be linked to jappleseed@icloud.com”). In some embodiments, the user may cancel the association via actuation of a digital button 100I.

After confirming the association (e.g., via actuation of digital button 100J), the purchased electronic device 58 may receive pricing from the back end computing device 56 and may display the current pricing of the electronic service product in addition to a prompt to the user to confirm the purchase of the electronic service products determined at the block 210. FIG. 15B-D are illustrations depicting a linking flow associated with the method for activating and renewing subscriptions. FIG. 15B is an illustration of a graphical user interface that prompts a user to confirm a purchase based at least in part on electronic service product pricings before continuing to a payment screen. In response to completing the prompt in a substantially suitable manner, an indication of a payment initial set-up may be transmitted from the purchased electronic device 58 to the back end computing device 56. The indication of payment initial set-up may begin or facilitate linking the user, the preferred payment method of the user, an electronic service product, and the purchased electronic device 58. After confirming the purchase, FIG. 15C is an illustration of a graphical user interface of the purchased electronic device 58 that prompts the user to enter a payment method (e.g., similar to the block 212). In some embodiments, the purchased electronic device 58 does not prompt the user to enter a payment method when the purchased electronic device 58 or the back end computing device 56 determines that the purchased electronic device 58 was a gift to the user. However, for certain electronic service products (e.g., ones that act as subscriptions that may have service periods renewed on a predetermined frequency), the purchased electronic device 58 may prompt a user to enter a preferred method of payment to process future purchases of the electronic service product. This prompting, in this example, may occur even if the customer ordered one or more service periods associated with the electronic service product for the user (e.g., as a gift) when the customer purchased the purchased electronic device 58. The purchased electronic device 58 may transmit the preferred payment method to the back end computing device 56, which may store the preferred payment method for the user to automatically initiate and process future service period renewals, such as after pre-paid, pre-committed to be purchased, or gifted, service periods expire (e.g., are to be renewed).

Furthermore, in some embodiments, the purchased electronic device 58 does not prompt the user to enter a payment method when the purchased electronic device 58 or the back end computing device 56 determines that the user has a preferred payment method already stored in the database. The stored payment method used to complete the purchase of the purchased electronic device 58 may correspond to the preferred payment method of the user, and thus may be automatically populated for the user based on data transmitted from the back end computing device 56. The unique device identifier of the purchased electronic device 58 may be associated with the payment method in the database 60. In some embodiments, the purchased electronic device 58 may automatically populate a data field 102C with a stored payment method for the user and additionally prompt the user to enter a security code into a data field 102D for the stored payment method as a method to validate that the user has permission to use the payment method. FIG. 15D is an illustration of a graphical user interface that provides the user confirmation of activation of the purchased electronic service products. The user may be prompted with one or more additional digital buttons 100 to facilitate use of the purchased electronic device 58.

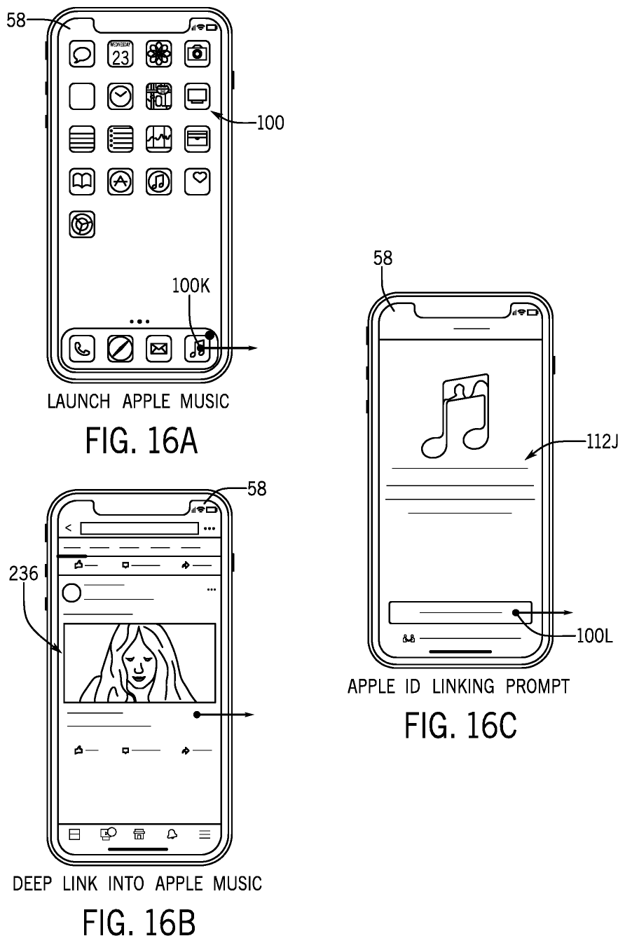

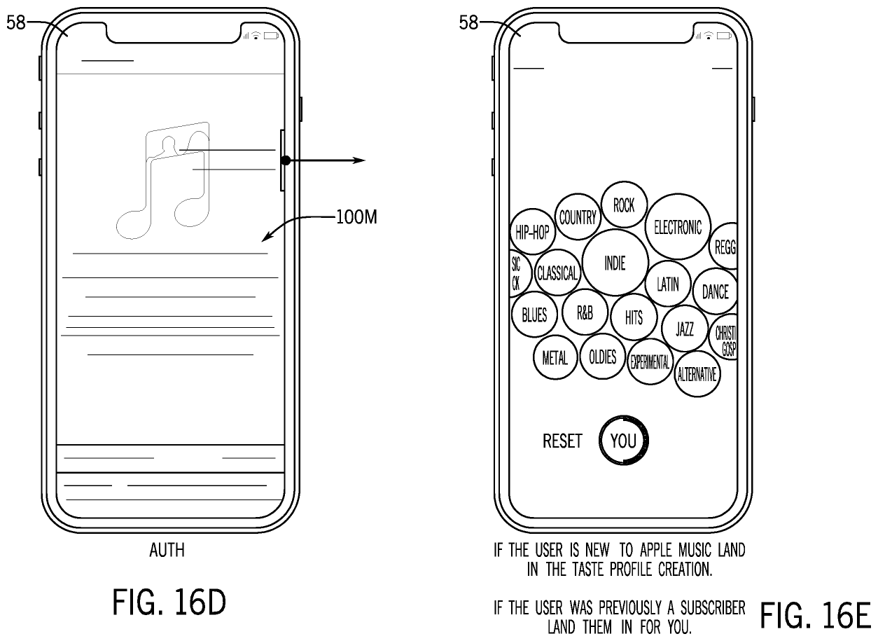

To help explain qualifying events, as used at the block 172 of the process 138 and the block 196 of the process 186, FIG. 16A-E are illustrations depicting an example of a qualifying event. FIG. 16A is an illustration of a graphical user interface including multiple digital buttons 100. In some cases, the qualifying event is an actuation of a digital button 100K by the user. For example, after the user presses the digital button 100K, the qualifying event is transmitted from the purchased electronic device 58 to the back end computing device 56 to verify that the qualifying event is suitable to activate an electronic service product. FIG. 16B is an illustration of a graphical user interface including an example of digital content 236. In some cases, the digital content 236 may be hyperlinked to a software application corresponding to an electronic service product. After the user selects the digital content 236 (e.g., as a way to engage, listen, consume, and/or watch the digital content 236), the qualifying event is transmitted from the purchased electronic device 58 to the back end computing device 56 to verify that the qualifying event is suitable to activate an electronic service product. FIG. 16C is an illustration of a graphical user interface presented to the user to activate the electronic service product the qualifying event was suitable to initiate activation. As depicted, the electronic service product (e.g., Apple Music) is launched in response to either the actuation of the digital button 100K and/or by the selection of the digital content 236. The graphical user interface also depicts an embodiment of the association notification. In this embodiment, the user is notified of the association between the customer login information and the purchased electronic device via the indication 112J (e.g., “will be linked to jappleseed@icloud.com”). After the user confirms the association via digital button 100L, a graphical user interface is displayed via the purchased electronic device 58. FIG. 16D is an illustration of the graphical user interface displayed after the association. The purchased electronic device 58 may transmit the confirmation of the association to the back end computing device 56 that determines if there is an existing electronic service product account for the customer login information. As depicted, the back end computing device 56 has found an existing electronic service product account for the customer login information, and presents this via the purchased electronic device 58 through the indication 112J. This graphical user interface includes a digital button 100M that the user actuates to confirm the association of the existing electronic service product account to the customer login information and the purchased electronic device 58. FIG. 16E is an illustration of a graphical user interface presented to the user after the user confirms the association via the digital button 100H, or any suitable method of confirmation. This graphical user interface represents an initial screen of the electronic service product that may guide a user to initialize the electronic service product and settings or features of the electronic service product. As depicted, the user is prompted to provide musical preferences for use in the electronic service product. In some embodiments, these additional user preferences are transmitted from the purchased electronic device 58 to the back end computing device 56 to enhance user experiences in different situations (e.g., such as recommendations for other electronic service products based on the entered musical preferences).

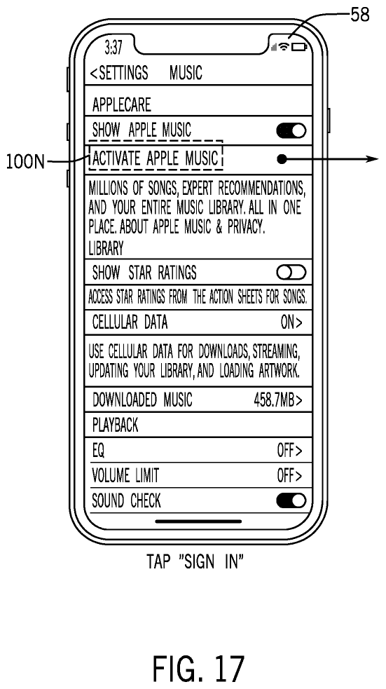

As an additional example of a qualifying event, FIG. 17 is an illustration a graphical user interface presenting a setting menu associated with the purchased electronic device 58 to a user. In this example, the user may select a setting, and the selection may initiate a qualifying event to transmit to the back end computing device 56. In this way, the user may actuate a digital button 100N. In response to the user selection, the purchased electronic device 58 may transmit a control signal to the back end computing device 56 to be interpreted as the qualifying event for the electronic service product (e.g., Apple Music).

It should be noted that the features described above are optional and may be used in various combinations. For example, the block 212, the block 224, and/or the block 226 of the process 186 may be excluded from the process 186. In addition, one purchased electronic device 58 may have more than one electronic service products associations at one time. Furthermore, the electronic service product provider 62, although depicted in FIG. 2 as being separate from the back end computing device 56, in some embodiments, the back end computing device 56 includes, or in some cases replaces, the electronic service product provider 62.

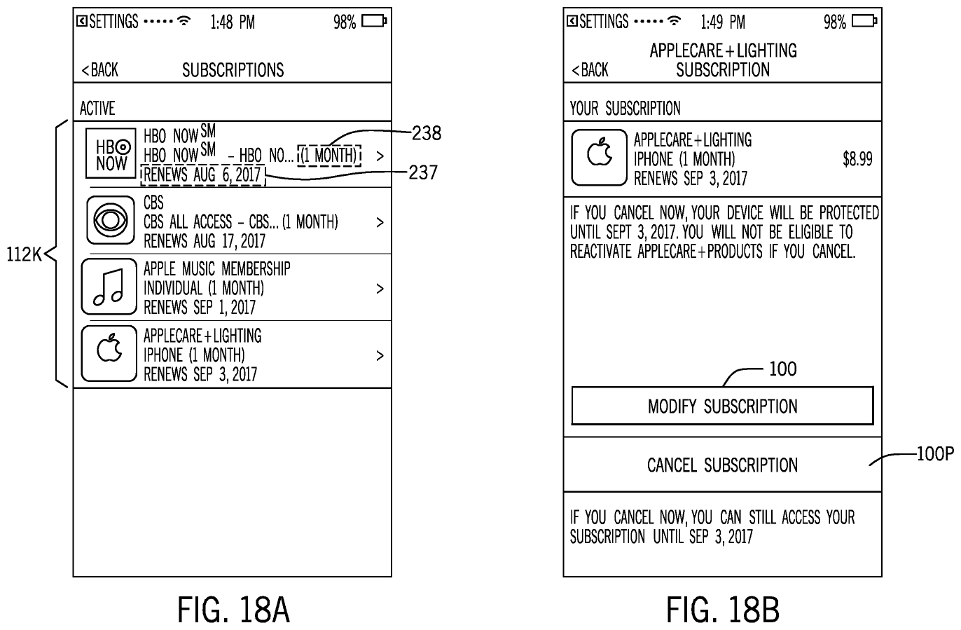

To elaborate, FIG. 18A-B is an illustration depicting multiple activated subscriptions. FIG. 18A is an illustration of a graphical user interface of the purchased electronic device 58 presenting to the user indications 112K of activated electronic service products. This summarizing graphical user interface may enhance user experience by consolidating and simplifying management of electronic service products. In this example, the purchased electronic device 58 presents relevant renewal dates (e.g., date 237) and subscription periods (e.g., period 238) for the electronic service products. For example, an electronic service product (e.g., AppleCare+ Lightning) is set to renew on Sep. 3, 2017, and thus the user knows the preferred payment method for the user is set to the processed on the renewal date. In addition, in some embodiments, the user may select an electronic service product to navigate to a preferences page associated with the electronic service product. To help illustrate, FIG. 18B is an illustration of a graphical user interface of the purchased electronic device 58 presenting to the user the preferences page associated with an electronic service product (e.g., AppleCare+ Lightning). After navigation to the preferences page, the user is presented with two options. The first option is to modify the subscription (e.g., digital button 100O) and the second option (e.g., digital button 100P) is to cancel the subscription. A user may thus interact with and manage the electronic service products through one or more digital buttons 100.

In some embodiments, as described above, a shipment notification may initiate or prompt activation of the electronic service product. In this way, the back end computing device 56 may receive the shipment notification from a third-party system or internal shipping tracking system, wherein the shipment notification communicates that the purchased electronic device 58 has been shipped to the user (where the user may be the same person or a different person from the customer). In response to the shipment notification, the back end computing device 56 may transmit an indication, or a fulfillment indication, to the electronic service product provider 62 to fulfil the electronic service product (e.g., initiate activation and purchase of the electronic service product). The electronic service product was ordered via the electronic service product order corresponding to the purchased electronic device 58 and thus is to be fulfilled on the purchased electronic device 58 in response to the shipment notification. An example of this may be an insurance electronic service product, where the electronic service product provider 62 may not want the insurance electronic service product to activate until the user of the purchased electronic device 58 actually possesses (e.g., owns, has) the purchased electronic device 58—which may not occur until after a shipment is received by the user. In addition, in some embodiments, one qualifying event may initiate simultaneous fulfillment of one or more electronic service products. Furthermore, in response to the fulfillment of the electronic service product, in some embodiments, a notification presented to a user via a graphical user interface may disappear (e.g., a push notification) or a may change (e.g., a depiction of a status related to the fulfillment).

Thus, the technical effects of the present disclosure include improvements to managing activations and payments corresponding to purchases of electronic service products, for example, through delaying activation and purchase of an electronic service product until a qualifying event. These techniques describe a back end computing device that selectively manages electronic service products based on whether a qualifying event for the particular electronic service product is received. In this way, multiple electronic service products may be purchased with an electronic device but each electronic service product may be selectively activated and purchased at different times based on when the particular qualifying event for that electronic service product is received by the back end computing device. These techniques describe and facilitate an improved manner managing activations of electronic service products as a way to improve user experience, such as providing a summarizing graphical user interface to improve user management of activated electronic service products.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
receiving a purchase payload comprising an electronic service order indication that specifies an electronic service product purchased proximate to a purchase of an electronic device with which the electronic service product is to be associated, wherein the purchase payload comprises a unique device identifier that identifies the electronic device and an electronic service identifier that identifies the electronic service product;
receiving a qualifying event indication associated with the electronic device indicating that a qualifying event associated with the unique device identifier has occurred; and
in response to the qualifying event, triggering activation of the electronic service product identified by the electronic service identifier for the electronic device identified by the unique device identifier.

2. The method of claim 1, wherein the electronic service product comprises a digital content service subscription.

3. The method of claim 1, wherein the electronic service product comprises an insurance product.

4. The method of claim 1, wherein the electronic device is a notebook computer, a hand-held device, a desktop computer, a wearable electronic device, a watch, a cellular device, a laptop, a tablet, or any combination thereof.

5. The method of claim 1, wherein the qualifying event comprises linking a unique user identifier to the electronic service product, power up of the electronic device, activating the electronic service product, acquiring the electronic device, interacting with a digital content, actuating a digital button, or any combination thereof.

6. The method of claim 1, wherein the unique device identifier comprises a serial number uniquely provided to the electronic device at a time of manufacturing.

7. The method of claim 1, wherein the unique device identifier comprises a media access control (MAC) address.

8. The method of claim 1, wherein activating the electronic service product comprises:
determining whether the electronic service order was initiated by a customer for a user, wherein the customer provided a first payment method at an order time;
in response to determining the electronic service order corresponds to a purchase of a gift, requesting the user enter a second payment method; and
after receiving the second payment method, processing the first payment method to complete a purchase of the electronic service product.

9. The method of claim 1, comprising instructing the electronic device to present a summarizing graphical user interface to a user associated with a renewal date of the electronic service product that is based upon a date of the qualifying event.

10. The method of claim 1, wherein the activating of the electronic service product is configured to occur at a first time in response to the qualifying event, and wherein activating an additional electronic service product is configured to occur at a second time in response to an additional qualifying event for the electronic device.

11. The method of claim 1, comprising:
transmitting a preferred payment method to the electronic device; and
receiving verification a user comprises permission to use the preferred payment method to complete the activating of the electronic service product.

12. A tangible, non-transitory, machine-readable media storing instructions executable by one or more processors of an electronic device, wherein the instructions, when executed by the one or more processors, cause the one or more processors to:
transmit a control signal to a back end computing device, wherein the control signal indicates that a qualifying event has occurred; and
receive, in response to the control signal, an association notification confirming a purchase of an electronic service product associated with a previously generated electronic service order that was generated at a time when an electronic device associated with the electronic service product was purchased.

13. The machine-readable media of claim 12, comprising instructions that cause the one or more processors to update a graphical user interface to communicate an association of the electronic service product to the electronic device.

14. The machine-readable media of claim 12, comprising instructions that cause the one or more processors to:
provide a first prompt to confirm the association between the electronic device and the electronic service product;
in response to receiving an association confirmation, provide a second prompt to enter preferred payment method information; and
transmit the preferred payment method information to initiate processing of the preferred payment method information.

15. The machine-readable media of claim 12, comprising instructions that cause the one or more processors to:
determine whether the previously generated electronic service order corresponds to a purchase of a gift; and
in response to determining the previously generated electronic service order corresponds to the purchase of a gift, initiate processing of a customer payment method, wherein the customer payment method was provided at the time when the electronic device associated with the electronic service product was purchased.

16. A tangible, non-transitory, machine-readable media storing instructions executable by one or more processors of an electronic device, wherein the instructions comprise instructions to:
receive, from a point of sale computing device at an order time, a device indicator of an electronic device and a service indicator of an electronic service product ordered when the electronic device is purchased;
link the service indicator to the device indicator;
receive, at a fulfillment time, a fulfillment indication to fulfil purchasing of the electronic service product; and
trigger fulfillment of the electronic service product in response to the fulfillment indication.

17. The machine-readable media of claim 16, comprising instructions that cause the one or more processors to:
store an identifier of a digital profile of a user, the device indicator, and the service indicator within a database.

18. The machine-readable media of claim 16, wherein the fulfillment indication comprises an indication of a completed shipment of the electronic device.

19. The machine-readable media of claim 16, wherein the fulfillment indication comprises an indication of initial set-up of the electronic device.

20. The machine-readable media of claim 16, wherein the fulfillment indication comprises an indication of an initial request for use of the electronic service product.
